(19) United States
(12) Patent Application Publication
(10) Pub. No.: US 2026/0157396 A1
(43) Pub. Date: Jun. 11, 2026

(54) METHOD AND COMPOSITION FOR ENZYME CHELATION OF TRACE MINERALS

(71) Applicant: Cenzone Tech Inc., San Marcos, CA (US)

(72) Inventors: Jung Fu Wu, San Marcos, CA (US); Efan Wu, San Marcos, CA (US)

(73) Assignee: Cenzone Tech Inc., San Marcos, CA (US)

(21) Appl. No.: 19/150,110

(22) PCT Filed: Dec. 19, 2023
(86) PCT No.: PCT/US2023/084957

§ 371 Date: Jul. 22, 2025

Related U.S. Application Data
(60) Provisional application No. 63/440,824, filed on Jan. 24, 2023.

(51) Int. Cl. A23K 10/14; A23K 10/18; A23K 20/163; A23K 20/189; A23K 20/20; A23K 40/00

(52) U.S. Cl. CPC A23K 10/14; A23K 10/18; A23K 20/163; A23K 20/189; A23K 20/30; A23K 40/00

(57) ABSTRACT

The disclosure concerns a method of chelating trace minerals for animal feed additive, wherein the chelating agent is one or more enzymes. In one aspect, the method of manufacturing chelated minerals with enzymes includes adding a composition into a volume of water, the composition including a chelating agent and one or more metal salts to form a solution wherein the chelating agent is one or more enzymes. The one or more metal salts have one or more trace minerals. The solution is mixed in order for the one or more enzymes to chelate the one or more trace minerals. The solution is filtered to separate undissolved substances from a filtrate, and the filtrate is dried to form the product.

### TECHNICAL FIELD

This invention relates to chelation of trace minerals; more particularly, the chelation of trace minerals with enzymes to increase digestibility and bioavailability.

### BACKGROUND ART

Feed additives are commonly added to animal feed for poultry, livestock, aquaculture, and domesticated animals to provide additional nutrients. Trace minerals can be added to animal feed to avoid a variety of deficiency diseases. Minerals can also help carry out functions in relation to many metabolic processes. Conventional processes to enhance mineral absorption involved chelating the trace minerals with amino acids to form metal amino acid chelates in order to shield the metal ions to avoid damage or destruction during transport through the low-pH stomach and rumen environments.

### SUMMARY OF INVENTION

### Technical Problem

Conventional processes using amino acids and other compounds as a chelating agent have provided moderate benefits to the animal agriculture industry for decades. However, with the continuing increase in cost and demand for raising animals, improvements in animal feed digestibility and bioavailability are needed.

### Solution to Problem

In one aspect, a method of manufacturing chelated minerals with enzymes is disclosed. The method comprises adding a composition into a volume of water, the composition comprising a chelating agent and one or more metal salts to form a solution wherein the chelating agent comprises one or more enzymes. The one or more metal salts comprise one or more trace minerals. The solution is mixed in order for the one or more enzymes to chelate the one or more trace minerals. The solution is filtered to separate undissolved substances from a filtrate, and the filtrate is dried.

In another aspect, a method of manufacturing chelated minerals for animal feed additive is disclosed. The method comprises (i) forming a solution by combining into a volume of water a silica medium and a composition, the composition comprising a chelating agent and one or more metal salts, the one or more metal salts comprising one or more trace minerals, wherein the chelating agent comprises one or more enzymes; (ii) adjusting the pH of the solution to between and inclusive of 6.5-6.7; (iii) chelating the one or more trace minerals with the one or more enzymes by mixing the solution; (iv) filtering the solution to separate undissolved substances from a filtrate; and (v) drying the filtrate to form a powder.

### Advantageous Effects of Invention

Enzymes have a 3D folding structures that allows them to easily encapsulate and protect metal ions to avoid damage and destruction during transport. Enzymes used as a chelating agent allows the minerals to reach the epithelium of an animal's intestinal mucosa for improved nutritional absorption. Additionally, enzymes have an intrinsic nutritional value that can help maximize the animals' ability to digest food components and efficiently absorb nutrients for peak performance.

Certain types of enzymes can kill viral infections to lower disease and mortality rates. Generally, the outer layer of virus particles will be protected by a film formed of a protein. But as long as the virus particle encounters the enzyme complex containing enzymes such as protease, it can decompose the outer layer of the film and cause the virus particles to die.

The added protection of the enzyme chelate allows reduction of other nutritional additives without sacrificing results.

Manufacturing of enzyme metal salt complex can be performed at room temperature conditions, thereby lowering manufacturing costs.

Enzymes used as a chelating agent for trace minerals can promote better feed digestion, increase nutrient absorption, reduce odorous feces, enhance immunity against virus infections, increase the survival rates in young animals, reduce the costs in medications, and improve feed efficiency resulting in a better harvest.

### BRIEF DESCRIPTION OF THE DRAWINGS

Other features, combinations, and embodiments will be appreciated by one having the ordinary level of skill in the art of antennas and accessories upon a thorough review of the following details and descriptions, particularly when reviewed in conjunction with the drawings, wherein:

FIG. 1 shows a bar graph comparing body weight of nursery pigs between enzyme chelated feed additives and conventional products;

FIG. 2 shows a bar graph comparing average daily gain of nursery pigs between enzyme chelated feed additives and conventional products;

FIG. 3 shows a bar graph comparing average daily feed intake of nursery pigs between enzyme chelated feed additives and conventional products; and

FIG. 4 shows a bar graph comparing weight and consumption to gain: feed consumption of nursery pigs between enzyme chelated feed additives and conventional products.

### DETAILED DESCRIPTION

For purposes of explanation and not limitation, details and descriptions of certain preferred aspects and embodiments are hereinafter provided such that one having ordinary skill in the art may be enabled to make and use the invention. These details and descriptions are representative only of certain preferred aspects and embodiments, however, a myriad of other aspects and embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “silica medium” means diatomaceous earth, kaolinite, montmorillonite, or the like.

The term “w/w” means percent weight of total powder composition.

The term “distilled water” means water that has been boiled into a vapor and condensed back into a liquid.

The term “room temperature” means between and inclusive of 20-30° C.

The term “free amino acid” means amino acids devoid of peptide bonds. Free amino acids include, but not limited to, L-glycine, threonine, L-Tryptophan, DL-methionine, L-lysine, and L-valine. Free amino acids comprise a molecular weight less than 300 Dalton.

Unless explicitly defined herein, terms are to be construed in accordance with the plain and ordinary meaning as would be appreciated by one having skill in the art.

### General Description of Embodiments

In one aspect, a method of manufacturing chelated minerals for animal feed additive is disclosed. The method comprises: (i) forming a solution by combining into a volume of water a silica medium and a composition, the composition comprising a chelating agent and one or more metal salts, the one or more metal salts comprising one or more trace minerals, wherein the chelating agent comprises one or more enzymes; (ii) adjusting the pH of the solution to between and inclusive of 6.5-6.7; (iii) chelating the one or more trace minerals with the one or more enzymes by mixing the solution; (iv) filtering the solution to separate undissolved substances from a filtrate; and (v) drying the filtrate to form a powder.

A skilled artisan will appreciate that some limited amount of chelation will occur prior to mixing when the one or more enzymes and the one or more trace minerals are introduced together. The mixing step allows the chelation process to occur more efficiently which is where a substantial amount of the chelation process takes place.

In some aspects, the one or more enzymes may comprise a one or more digestive enzymes. The one or more digestive enzymes may comprise protease, cellulase, amylase, xylanase, hemicellulase, beta glucanase, phytase, lipase, mannanase, or a combination thereof. Non-digestive enzymes can also be used for the chelation process but would not provide beneficial merits in helping animal health and enhancing growth.

In some aspects, the one or more digestive enzymes may comprise a multiple enzyme mixture, the multiple enzyme mixture comprising: amylase in an amount between and inclusive of 25.0% to 30.0% of the multiple enzyme mixture, hemicellulase in an amount between and inclusive of 5.0% to 8.0% of the multiple enzyme mixture, cellulase in an amount between and inclusive of 10.0% to 15.0% of the multiple enzyme mixture, xylanase in amount between and inclusive of 5.0% to 7.0% of the multiple enzyme mixture, beta glucanase in an amount between 1.0% to 3.0% of the multiple enzyme mixture, protease in an amount between and inclusive of 20.0% to 40.0% of the multiple enzyme mixture, phytase in an amount between and inclusive of 2.0% to 5.0% of the multiple enzyme mixture, mannanase in an amount between and inclusive of 0.5% to 1.0% of the multiple enzyme mixture, and lipase in an amount between and inclusive of 2.0% to 5.0% of the multiple enzyme mixture.

In some aspects, the one or more enzymes may comprise 20% to 95% w/w of the composition. Too low of the one or more enzymes would not allow for sufficient chelation nor it would it provide enough health benefits to the animal Too much of the one or more enzymes can have adverse effects on animal growth, feed uptake, and conversion efficiency.

In some aspects, the chelating agent may be devoid of free amino acids. Free amino acids can only bind to one divalent metal ion (i.e. Zn²⁺, Cu²⁺, Fe²⁺, Co²⁺). Each enzyme can in theory bind to hundreds to thousands of divalent metal ions because enzyme molecules are made up of 100-80,000 amino acid molecules.

In some aspects, chelating the one or more trace minerals with the one or more enzymes by mixing the solution may occur at room temperature.

In some aspects, the silica medium may comprise diatomaceous earth. The diatomaceous earth may be a buffer colloid to stabilize the solution subsequent to the pH adjustment.

In some aspects, the pH of the solution may be adjusted with an organic acid. The organic acid may comprise citric acid.

In some aspects, the composition may further comprise Beta glucan. Beta glucan is a strong immune enhancer for the animals. The enzymes' tertiary structure can hold the Beta glucan to the intestine, then activate the macrophage to engulf as virus particles and tox molecules, thereby promoting health. Conventional chelating processes that use amino acids to not include Beta glucan because the amino acid's binding sites can interact with the Beta glucan molecules which could significantly reduce chelating effectiveness or binding capacities of the amino acid molecules.

The Beta glucan may comprise β-(1-3), (1-6)-D-glucan. The Beta glucan may be derived from fungi. The composition may further comprise one or more probiotics. The one or more probiotics may comprise Bacillus subtilus, Saccharomyces cerevisiae, Aspergillus niger, Aspergillus oryzae, Lactobacillus acidophilus, Lactobacillus bulgaricus, Enterococcus faecium, or a combination thereof.

In some aspects, the composition may further comprise one or more probiotics. The one or more probiotics may comprise Bacillus subtilus, Saccharomyces cerevisiae, Aspergillus niger, Aspergillus oryzae, Lactobacillus acidophilus, Lactobacillus bulgaricus, Enterococcus faecium, or a combination thereof. In some aspects, the one or more probiotics may be encapsulated in oligosaccharides

In some aspects, the water may further comprise distilled water. The distilled water may be maintained at room temperature during mixing of the solution. Distilled water is substantially devoid of any dissolved organic or inorganic materials which might interfere with the chelating agents of the enzymes. Also, distilled water contains minute cations and anions that provides preferable conditions for maximizing the chelation process with enzymes.

In some aspects, the one or more trace minerals may comprise zinc, copper, manganese, cobalt, chromium, iron, or a combination thereof.

In some aspects, each of the one or more trace minerals may be added prior to mixing of the solution.

In some aspects, forming the solution by combining into the volume of water the silica medium and the composition may further comprise forming a first mixture of the silica medium and water, forming a second mixture of the composition and water, and combining the first mixture with the second mixture.

In another aspect, a method of manufacturing chelated minerals is disclosed. The method comprises: (i) adding a composition into a volume of water, the composition comprising a chelating agent and one or more metal salts to form a solution, the one or more metal salts comprise one or more trace minerals, wherein the chelating agent comprises one or more enzymes; (ii) chelating the one or more trace minerals with the one or more enzymes by mixing the solution; (iii) filtering the solution to separate undissolved substances from a filtrate; and (iv) drying the filtrate to form a powder.

In some aspects, the method may further comprise adding a silica medium in the volume of water. The silica medium may further comprise diatomaceous earth. In some aspects, the diatomaceous earth may be a buffer colloid to stabilize the solution subsequent to the pH being adjusted

In some aspects, the one or more enzymes may comprise one or more digestive enzymes. The one or more digestive enzymes may comprise protease, cellulase, amylase, xylanase, hemicellulase, beta glucanase, phytase, lipase, mannanase, or a combination thereof. The one or more digestive enzymes may comprise a multiple enzyme mixture, the multiple enzyme mixture comprising: amylase in an amount between and inclusive of 25.0% to 30.0% of the multiple enzyme mixture, hemicellulase in an amount between and inclusive of 5.0% to 8.0% of the multiple enzyme mixture, cellulase in an amount between and inclusive of 10.0% to 15.0% of the multiple enzyme mixture, xylanase in amount between and inclusive of 5.0% to 7.0% of the multiple enzyme mixture, beta glucanase in an amount between 1.0% to 3.0% of the multiple enzyme mixture, protease in an amount between and inclusive of 20.0% to 40.0% of the multiple enzyme mixture, phytase in an amount between and inclusive of 2.0% to 5.0% of the multiple enzyme mixture, mannanase in an amount between and inclusive of 0.5% to 1.0% of the multiple enzyme mixture, and lipase in an amount between and inclusive of 2.0% to 5.0% of the multiple enzyme mixture.

In some aspects, the one or more enzymes may comprise 20% to 95% w/w of the composition.

In some aspects, the chelating agent may be devoid of free amino acids. The chelating agent may consist of one or more enzymes.

In some aspects, chelating the one or more trace minerals with the one or more enzymes by mixing the solution may occur at room temperature.

In some aspects, the method may further comprise adjusting the pH of the solution to between and inclusive of 6.5-6.7 prior to chelating the one or more trace minerals with the one or more enzymes by mixing the solution. The pH of the solution may be adjusted with an organic acid. In some aspects, the organic acid may comprise citric acid. Amount of organic acid for adjustment of the pH can vary. A sufficient amount of organic acid should be added until the pH of the solution is between and inclusive of 6.5-6.7. A pH range of near neutral provides a better environment to the one or more enzymes and the one or more probiotics. If pH too low can provide unstable complex formation.

In some aspects, the composition may further comprise Beta glucan. The Beta glucan may comprise β-(1-3), (1-6)-D-glucan. The Beta glucan may be derived from fungi. The composition may further comprise one or more probiotics. The one or more probiotics may comprise Bacillus subtilus, Saccharomyces cerevisiae, Aspergillus niger, Aspergillus oryzae, Lactobacillus acidophilus, Lactobacillus bulgaricus, Enterococcus faecium, or a combination thereof.

In some aspects, the composition may further comprise one or more probiotics. The one or more probiotics may comprise Bacillus subtilus, Saccharomyces cerevisiae, Aspergillus niger, Aspergillus oryzae, Lactobacillus acidophilus, Lactobacillus bulgaricus, Enterococcus faecium, or a combination thereof.

In some aspects, the water may further comprise distilled water. The distilled water may be maintained at room temperature throughout the method.

In some aspects, the one or more trace minerals may comprise zinc, copper, manganese, cobalt, iron, or a combination thereof.

In some aspects, the method may perform a single mixing step after all of the one or more metal salts are added to the solution.

In one embodiment, a feed additive composition is disclosed. The composition comprises one or more trace minerals and one or more enzyme chelation molecules enfolding the one or more trace minerals.

### Example 1

### Multiple Enzyme Mixture Composition Concentration.

In one embodiment, a composition for a multiple enzyme mixture is disclosed. The multiple enzyme mixture comprises 25.0% to 30.0% of amylase, 5.0% to 8.0% of hemicellulase, 10.0% to 15.0% of cellulase, 5.0% to 7.0% of xylanase, 1.0% to 3.0% of beta glucanase, 20.0% to 40.0% of protease, 2.0% to 5.0% of phytase, 0.5% to 1.0% of mannanase, and 2.0% to 5.0% of lipase.

### Example 2

### Preparation of Enzyme-Chelated Minerals.

Combine into 300 liters of distilled water: 0.227 kg of Paecilomyces powder, 5 kg of Bacillus subtilis premix, 8 kg Saccharomyces cerevisiae, and 12.3 kg of diatomaceous earth. Add 75.0 kg of a multiple enzyme mixture into the tank and adjust pH to between 6.5-6.7 by adding citric acid. Add the following metal salts: 15.6 kg zinc sulfate, 8.4 kg manganese sulfate, 7.2 kg copper sulfate, and 2.4 kg iron sulfate. Under room temperature, mix the tank solution to form diatomaceous chelates with the multiple enzyme mixture. Filtrate the solution and discard the undissolved substance. Dry the supernatant to form the final product. Conduct quality control to ensure Bacillus subtilis is 23 million cfu/g, and Saccharomyces cerevisiae is 212 million cfu/g.

Trace mineral content shown in Table 1.

TABLE 1
Trace mineral content.

| | | |
|---|---|---|
| Aluminum | 66.61 | ppm |
| Barium | 1.21 | ppm |
| Boron | 0.26 | ppm |
| Calcium | 45.44 | ppm |
| Chromium | 0.07 | ppm |
| Cobalt | 0.05 | ppm |
| Copper | 0.69 | ppm |
| Iron | 71.41 | ppm |
| Lanthanum | 0.11 | ppm |
| Magnesium | 17.01 | ppm |
| Manganese | 0.53 | ppm |
| Nickel | 0.07 | ppm |
| Phosphorus | 0.40 | ppm |
| Potassium | 5.06 | ppm |
| Silicon | 4653.6 | ppm |
| Sodium | 5.14 | ppm |
| Strontium | 0.52 | ppm |
| Sulfur | 0.39 | ppm |
| Titanium | 2.19 | ppm |
| Vanadium | 0.51 | ppm |
| Yttrium | 0.09 | ppm |
| Zinc | 0.27 | ppm |
| Zirconium | 0.28 | ppm |

### Example 3

### Preparation of Enzyme-Chelated Minerals.

Add 2500 g of a multiple enzyme mixture into a 20-liter flask that contains 8.0 g of Paecilomyces species premix, 167 g of Bacillus subtilis premix, 275 g of Saccharomyces cerevisiae premix, and 410 g diatomaceous earth with 10 liters of distilled water. Adjust pH to 6.5-6.7 by adding citric acid. Add 195.2 g Cu(OH) 2, 554.2 grams MnSO₄·7H2O, 162.8 g ZnO and 237.8 g CoCO₃ to the solution. Mix the solution that contains the trace minerals in the 20-liter flask continuously for about 45 minutes under room temperature to form diatomaceous colloidal chelate with the multiple enzyme mixture. Filter the solution to discard the undissolved substances. Dry the filtrate at 45° C. until powder forms.

### Example 4

### Preparation of Enzyme-Chelated Minerals.

Combine 19.5 kg of a multiple enzyme mixture, 1.02 kg Paecilomyces mushroom powder, and 0.9 kg Saccharomyces cerevisiae yeast culture into 100 liters of distilled water. Add 0.6 kg ferrous sulfate, 2.0 kg zinc sulfate, 0.9 kg copper sulfate, and 1.2 kg manganese sulfate. Adjust the pH to between and inclusive of 6.5-6.7 by adding citric acid. At room temperature, mix the tank solution until chelate formation, for approximately 45 minutes. Filter to remove any undissolved substances. Heat to remove water to form a powder. Use atomic absorption analysis to make sure content is 2.6% zinc, 0.9% copper, and 1.5% manganese, and Saccharomyces cerevisiae is 100 million cells per kilo.

### Example 5

### Preparation of Enzyme-Chelated Minerals.

Combine 18.75 kg of a multiple enzyme mixture, 1.0 kg Paecilomyces mushroom powder, 0.9 kg Saccharomyces cerevisiae yeast culture and add to a tank of 100-liter distilled water. Add 0.6 kg ferrous sulfate, 3.9 kg zinc sulfate, 1.8 kg copper sulfate, and 2.1 kg manganese sulfate. Adjust the pH to between and inclusive of 6.5-6.7. At room temperature, mix the tank solution until chelate formation, approximately 45 minutes. Filter to remove undissolved substances. Heat to remove water to form a powder. Use atomic absorption analysis to make sure content is 5.2% zinc, 1.8% copper, and 3.0% manganese, and Saccharomyces cerevisiae is 100 million cells per kilo.

### Example 6

### Evaluation of Enzyme Chelated Feed Additive on Nursey Pigs for Growth Performance and Serological Indices

### Experimental Design and Animal Management

A total of 220 crossbred barrows and gilts were weaned at 21 days of age with a mean body weight of 6.80±0.18 kg. Pigs were blocked by sex and body weight and subsequently randomly allotted within blocks to 1 of 5 dietary treatments. Pigs were housed in 55 nursery pens (20, 20, and 15 pens in 3 near identical nursery rooms) with 4 pigs per pen, resulting in 11 blocks per dietary treatment. Each pen housed 2 barrows and 2 gilts. If littermates were present within a particular pen, one of the littermates was exchanged with a pig with the approximate same body weight and of the same sex from another pen within the same weight block. Dietary treatment groups were then randomly allocated to the experimental units (pens). Pigs were allowed ad libitum access to feed and water during the 41-day experimental period. Fresh feed was added to the self-feeders as needed to ensure that fresh feed was always available. Feed consumption was calculated weekly from feed added to the feeder minus feed left in the feeder at the end of the feeding phase minus any waste feed removed from the feeders.

### Experimental Diets and Manufacturing

Nursery pigs were fed in 3 phases throughout the nursery. Phase 1 diets were fed from day 0 to 14, Phase 2 diets from day 14 to 25, and Phase 3 diets from day 25 to 40 Dietary treatments (Table 2) consisted of:
(1) Negative control diet (NC) without supplemental Cu, Zn, and Mn; The negative control diet contained 110, 100, and 80 ppm of Fe from FeSO₄ for dietary phases 1 to 3, respectively;
(2) Positive control diet (PC) with 24.3, 70.2, and 40.5 ppm of Cu, Zn, and Mn, respectively, from sulfate sources. This diet contained and additional 40.5 ppm of Fe from FeSO₄ for all diet phases;
(3) Diet of AVAILA MIN (AMIN) with 24.3, 70.2, and 40.5 ppm of Cu, Zn, and Mn, respectively, from amino acid complexes (Availa-minerals). This diet contained an additional 40.5 ppm of Fe from FeSO₄;
(4) Diet of enzyme chelated feed additive composition 1 (EC1) with 12.15, 35.10, and 20.25 ppm of Cu, Zn, and Mn, respectively (0.135% inclusion rate). This diet contained an additional 20.25 ppm of Fe from FeSO₄ and 20.25 ppm of Fe; and
(5) Diet of enzyme chelated feed additive composition 2 (EC2) with 24.3, 70.2, and 40.5 ppm of Cu, Zn, and Mn, respectively (0.27% inclusion rate). This diet contained and additional 40.5 ppm of Fe.

TABLE 2
Description of dietary treatments and resulting supplemental
trace-mineral concentrations in experimental diets

| Treatment | Copper | Zinc | Manganese |
|---|---|---|---|
| 1 - NC | 0 | 0 | 0 |
| 2 - PC | 24.30 | 70.20 | 40.50 |
| 3 - AMIN | 24.30 | 70.20 | 40.50 |
| 4 - EC1 | 12.15 | 35.10 | 20.25 |
| 5 - EC2 | 24.30 | 70.20 | 40.50 |

TABLE 3
Ingredient composition of the final experimental diets when
using the basal diet mixture for each nursery phase.

| | Diet code | | | | |
|---|---|---|---|---|---|
| | 1 - A | 2 - B | 3 - C | 4 - D | 5 - E |
| | Treatment | | | | |
| | NC | PC | AMIN | EC1 | EC2 |
| | Color code | | | | |
| | Red | Orange | Violet | Blue | Green |
| Ingredient, % | | | | | |
| Basal diet mixture | 99.68 | 99.68 | 99.68 | 99.68 | 99.68 |
| Corn | 0.2700 | 0.2280 | 0.1365 | 0.1350 | 0.0000 |
| Microgrits* | 0.0500 | 0.0500 | 0.0500 | 0.0500 | 0.0500 |
| FeSO₄ | 0 | 0.2700 | 0.2700 | 0.1350 | 0 |
| CuSO₄ | 0 | 0.0097 | 0 | 0 | 0 |
| ZnSO₄ | 0 | 0.0198 | 0 | 0 | 0 |
| MnSO₄ | 0 | 0.0127 | 0 | 0 | 0 |
| Availa-Cu | 0 | 0 | 0.0243 | 0 | 0 |
| Availa-Zn | 0 | 0 | 0.0585 | 0 | 0 |
| Availa-Mn | 0 | 0 | 0.0507 | 0 | 0 |
| EC1&2 | 0 | 0 | 0 | 0.1350 | 0.2700 |

*Microgrits provided color for identification as shown above.

### Sampling and Measurements

Pigs were weighed individually at the start of the study and on day 7, 14, 21, 28, 35, and 41 to calculate average daily gain (ADG). Feed additions to the feeders were recorded and feed remaining in the feeders was determined at the end of each period at the same time pigs were weighed. Feed disappearance was calculated from feed added to the feeder minus feed left in the feeder. Average daily feed intake (ADFI) per pen was then calculated from feed consumed during the period divided by the total number of days for pigs within each pen. Feed efficiency was calculated as the ratio of average daily gain for each period (or phase) divided by the average daily feed intake for the period.

Blood samples were collected at the end of the nursery period (day 41) from one median pig per pen. Blood was collected via jugular venipuncture in vacuum tubes without additive (for serum) and trace-mineral grade tubes containing K2-EDTA (for plasma). Blood for serum chemistry measurements was centrifuged at 1,000×g for 20 min at 10° C. to collect serum. Serum samples were analyzed for total protein, albumin, globulin, aspartate aminotransferase (AST), alanine aminotransferase (ALT), alkaline phosphatase (AlkP), γ-glutamyltranspeptidase (GGTP), urea N, creatinine, glucose, Ca, P, Mg, K, Na, Cl, cholesterol, triglycerides, amylase, lipase, and creatine phosphokinase (CPK). Plasma samples were analyzed for cobalt, copper, manganese, molybdenum, zinc, and selenium using inductively coupled plasma mass spectrometry.

Subsamples of feed were collected during load out of the feed from the feed mixer to the bagging unit. Ten subsamples were obtained from equally spaced bags between the beginning of load out and the end of load out. Representative samples of the mixture (1,000 g) were obtained by splitting the samples obtained from the mixer using a sample splitting device. Samples of all diets were analyzed in duplicate for moisture, copper, zinc, manganese, and iron. Similarly, 2 separate representative samples of the enzyme chelated feed additive composition were analyzed for moisture, copper, zinc, manganese, and iron.

### Growth Performance Results

Supplementation of EC2 improved pig body weight when measured on day 7 (P=0.058), 14 (P=0.025), 21 (P=0.047), 35 (P=0.002) and at the end of the study (P=0.028). This resulted in improved ADG during day 0 to 14 (P=0.028) and overall (P=0.030).

TABLE 4
Growth performance of nursery pigs fed diets without supplemental trace-minerals or
trace-minerals supplemented from sulfate, amino acid complexes, or yeast sources.

| | | | | | | | P values | | |
|---|---|---|---|---|---|---|---|---|---|
| | Dietary treatments | | | | | | Main | NC vs | EC2 vs |
| Variable | NC | PC | AMIN | EC1 | EC2 | SEM | effect | PC | PC |

Body weight, kg

| | | | | | | | | | |
|---|---|---|---|---|---|---|---|---|---|
| Day 0 | 6.74 | 6.74 | 6.74 | 6.75 | 6.76 | 0.01 | 0.597 | 0.638 | 0.396 |
| Day 7 | 6.89 | 6.80 | 6.84 | 6.93 | 7.02 | 0.08 | 0.371 | 0.420 | 0.058 |
| Day 14 | 7.79^{a} | 7.75^{a} | 7.74^{a} | 7.90^{ab} | 8.24^{b} | 0.15 | 0.128 | 0.835 | 0.025 |
| Day 21 | 11.12^{ab} | 10.96^{a} | 11.21^{ab} | 11.22^{ab} | 11.71^{b} | 0.22 | 0.188 | 0.583 | 0.020 |
| Day 28 | 15.90^{ab} | 15.41^{a} | 15.75^{ab} | 15.39^{a} | 16.25^{b} | 0.30 | 0.216 | 0.228 | 0.049 |
| Day 35 | 21.45^{ab} | 20.47^{a} | 21.20^{ab} | 20.79^{a} | 22.19^{b} | 0.37 | 0.023 | 0.060 | 0.002 |
| Day 41 | 26.90^{ab} | 26.02^{a} | 26.84^{ab} | 26.36^{ab} | 27.46^{b} | 0.45 | 0.212 | 0.159 | 0.028 |

Average daily gain, g/d

| | | | | | | | | | |
|---|---|---|---|---|---|---|---|---|---|
| Day 0 to 7 | 22 | 8 | 15 | 25 | 38 | 11.5 | 0.442 | 0.384 | 0.071 |
| Day 7 to 14 | 129^{a} | 136^{ab} | 128^{a} | 139^{ab} | 174^{b} | 15.1 | 0.206 | 0.747 | 0.078 |
| Day 0 to 14 | 75^{a} | 72^{a} | 72^{a} | 82^{ab} | 106^{b} | 10.6 | 0.151 | 0.809 | 0.028 |
| Day 14 to 21 | 476 | 458 | 496 | 474 | 495 | 18.0 | 0.554 | 0.483 | 0.156 |
| Day 21 to 28 | 682^{a} | 637^{ab} | 650^{ab} | 596^{b} | 648^{ab} | 22.6 | 0.138 | 0.153 | 0.726 |
| Day 14 to 28 | 579^{a} | 548^{ab} | 573^{ab} | 535^{b} | 572^{ab} | 14.1 | 0.149 | 0.111 | 0.233 |
| Day 28 to 35 | 793^{ab} | 722^{c} | 778^{bc} | 772^{bc} | 850^{a} | 24.6 | 0.016 | 0.042 | 0.001 |
| Day 35 to 41 | 908 | 925 | 919 | 946 | 879 | 30.1 | 0.625 | 0.687 | 0.286 |
| Day 28 to 41 | 846 | 816 | 844 | 844 | 863 | 17.7 | 0.447 | 0.216 | 0.066 |
| Day 0 to 41 | 492^{ab} | 470^{a} | 491^{ab} | 478^{ab} | 505^{b} | 10.9 | 0.215 | 0.156 | 0.030 |

Average daily feed intake, g/d

| | | | | | | | | | |
|---|---|---|---|---|---|---|---|---|---|
| Day 0 to 7 | 116 | 103 | 108 | 122 | 126 | 9.2 | 0.385 | 0.302 | 0.085 |
| Day 7 to 14 | 239 | 239 | 238 | 263 | 267 | 12.1 | 0.241 | 0.966 | 0.010 |
| Day 0 to 14 | 178 | 171 | 173 | 192 | 197 | 9.9 | 0.266 | 0.613 | 0.073 |
| Day 14 to 21 | 521 | 536 | 546 | 557 | 575 | 19.7 | 0.387 | 0.586 | 0.169 |
| Day 21 to 28 | 849 | 837 | 852 | 818 | 885 | 23.9 | 0.413 | 0.718 | 0.164 |
| Day 14 to 28 | 685 | 686 | 699 | 687 | 730 | 19.6 | 0.470 | 0.958 | 0.126 |
| Day 28 to 35 | 1189^{ab} | 1113^{a} | 1166^{ab} | 1159^{a} | 1233^{b} | 31.3 | 0.049 | 0.079 | 0.010 |
| Day 35 to 41 | 1496 | 1476 | 1480 | 1498 | 1500 | 38.6 | 0.987 | 0.711 | 0.658 |
| Day 28 to 41 | 1331 | 1280 | 1311 | 1292 | 1356 | 29.7 | 0.393 | 0.220 | 0.077 |
| Day 0 to 41 | 716^{ab} | 698^{a} | 713^{ab} | 710^{ab} | 747^{b} | 16.6 | 0.363 | 0.436 | 0.050 |

Gain:feed, g/kg

| | | | | | | | | | |
|---|---|---|---|---|---|---|---|---|---|
| Day 0 to 7 | 90 | 44 | 69 | 158 | 263 | 88.9 | 0.447 | 0.711 | 0.091 |
| Day 7 to 14 | 526 | 561 | 538 | 524 | 640 | 46.4 | 0.396 | 0.584 | 0.241 |
| Day 0 to 14 | 396^{a} | 416^{ab} | 403^{ab} | 417^{ab} | 523^{b} | 41.8 | 0.220 | 0.727 | 0.079 |
| Day 14 to 21 | 923 | 860 | 909 | 852 | 862 | 26.9 | 0.238 | 0.101 | 0.955 |
| Day 21 to 28 | 812^{a} | 764^{ab} | 764^{ab} | 730^{b} | 732^{b} | 19.4 | 0.033 | 0.081 | 0.248 |
| Day 14 to 28 | 854^{a} | 802^{b} | 820^{ab} | 780^{b} | 785^{b} | 16.8 | 0.023 | 0.029 | 0.486 |
| Day 28 to 35 | 673^{ab} | 649^{a} | 667^{ab} | 690^{b} | 690^{b} | 12.9 | 0.168 | 0.201 | 0.033 |
| Day 35 to 41 | 611^{ab} | 625^{ab} | 620^{ab} | 638^{a} | 585^{b} | 14.9 | 0.170 | 0.488 | 0.070 |
| Day 28 to 41 | 641 | 638 | 644 | 653 | 637 | 8.9 | 0.704 | 0.829 | 0.923 |
| Day 0 to 41 | 691 | 674 | 687 | 674 | 676 | 9.6 | 0.592 | 0.207 | 0.871 |

^{abc}Means within a row without a common superscript are different (P < 0.05).
NC = Negative control
PC = Positive control
AMIN = supplemented with Availa-Copper, Availa-Zinc, and Availa-Manganese.
EC1 = Enzyme chelated feed additive composition 1
EC2 = Enzyme chelated feed additive composition 2
Pigs were fed a phase feeding program with 3 dietary phases of 14, 14, and 13 days each

These responses were directly related to ADFI, which was improved with the supplementation of EC2 during day 7 to 14 (P=0.010), day 28 to 35 (P=0.010), and overall (P=0.050). Feed efficiency tended (P<0.10) to be better for pigs fed EC2 when compared to the positive control during day 0 to 7, 0 to 14 (Phase 1), and 35 to 41 and was significantly improved during day 28 to 35 (P=0.033). Specific comparisons between the positive control, the diet with supplemental AVIN and EC2 are shown in Table 5, indicating similar positive responses as outlined above.

TABLE 5
Growth performance of nursery pigs fed diets supplemented with
equal amounts of trace-minerals from either sulfate (PC),
amino acid complexes (AMIN), or enzyme complexes (EC2).

| | | | | | P values | | | |
|---|---|---|---|---|---|---|---|---|
| | Dietary treatments | | | | | PC vs. | PC vs. | AMIN vs. |
| Variable | PC | AMIN | EC2 | SEM | Main | AMIN | EC2 | EC2 |

Body weight, kg

| | | | | | | | | |
|---|---|---|---|---|---|---|---|---|
| Day 0 | 6.74 | 6.74 | 6.75 | 0.010 | 0.488 | 0.619 | 0.475 | 0.239 |
| Day 14 | 7.75 | 7.74 | 8.26 | 0.121 | 0.011 | 0.955 | 0.008 | 0.007 |
| Day 28 | 15.41 | 15.75 | 16.27 | 0.240 | 0.068 | 0.318 | 0.022 | 0.150 |
| Day 41 | 26.02 | 26.84 | 27.50 | 0.390 | 0.048 | 0.141 | 0.016 | 0.253 |

Average daily gain, g/d

| | | | | | | | | |
|---|---|---|---|---|---|---|---|---|
| Day 0 to 14 | 72 | 72 | 108 | 11.7 | 0.010 | 0.989 | 0.007 | 0.007 |
| Day 14 to 28 | 548 | 573 | 572 | 13.3 | 0.329 | 0.190 | 0.214 | 0.979 |
| Day 28 to 41 | 816 | 844 | 863 | 14.5 | 0.084 | 0.165 | 0.030 | 0.349 |
| Day 0 to 41 | 470 | 490 | 506 | 9.5 | 0.049 | 0.136 | 0.016 | 0.267 |

Average daily feed intake, g/d

| | | | | | | | | |
|---|---|---|---|---|---|---|---|---|
| Day 0 to 14 | 171 | 173 | 197 | 7.7 | 0.049 | 0.864 | 0.026 | 0.037 |
| Day 14 to 28 | 686 | 699 | 730 | 18.9 | 0.279 | 0.637 | 0.122 | 0.263 |
| Day 28 to 41 | 1280 | 1311 | 1360 | 20.9 | 0.046 | 0.289 | 0.015 | 0.118 |
| Day 0 to 41 | 698 | 713 | 748 | 12.8 | 0.041 | 0.412 | 0.014 | 0.074 |

Gain:feed, g/kg

| | | | | | | | | |
|---|---|---|---|---|---|---|---|---|
| Day 0 to 14 | 416 | 403 | 532 | 34.9 | 0.037 | 0.798 | 0.031 | 0.019 |
| Day 14 to 28 | 802 | 820 | 785 | 14.5 | 0.256 | 0.358 | 0.436 | 0.104 |
| Day 28 to 41 | 638 | 644 | 636 | 5.2 | 0.508 | 0.385 | 0.800 | 0.279 |
| Day 0 to 41 | 674 | 687 | 677 | 7.0 | 0.365 | 0.185 | 0.815 | 0.290 |

PC = Positive control
AMIN = supplemented with Availa-Copper, Availa-Zinc, and Availa-Manganese.
EC2 = enzyme chelated trace minerals

### Serum Trace-Mineral Concentration Results

Serum concentrations of trace-minerals (Table 6) reported in the current experiment were all within expected published ranges for nursery pigs. Adequate ranges for swine, according to the Michigan State University Veterinary Diagnostic laboratory are 1.5-2.9 μg/mL for copper, 0.7-2.5 μg/mL for zinc, 0.8-2.9 ng/mL for manganese, and 125-290 ng/mL for selenium.

Pigs are at risk of deficiency diseases if the serum concentration of copper is less than 1.1 μg/mL and zinc is less than 0.6 μg/mL. None of the values in the present study were below these deficiency values. Cobalt and molybdenum were part of the analysis package and are presented here for completeness, but they are of no consequence for swine. Supplementation of EC2 increased serum concentrations of Zn compared to all other treatments and it increased serum concentrations of Mn when compared to the negative control diet. This suggests that the bioavailability of Zn was greater in EC2 compared to Zn from sulfate or amino acid complexes.

TABLE 6
Plasma concentrations of trace-minerals in nursery pigs fed diets without supplemental trace-minerals
or trace-minerals supplemented from sulfate, amino acid complexes, or enzyme complex sources.

| | | | | | | | P values | | |
|---|---|---|---|---|---|---|---|---|---|
| | Dietary treatments | | | | | | Main | NC | EC2 |
| Variable | NC | PC | AMIN | EC1 | EC2 | SEM | effect | vs PC | vs PC |
| Zinc, μg/mL | 0.870^{a} | 0.929^{a} | 0.937^{a} | 0.949^{a} | 1.122^{b} | 0.03 | <0.001 | 0.245 | <0.001 |
| Manganese, ng/mL | 2.37^{a} | 2.84^{ab} | 2.82^{ab} | 2.65^{ab} | 3.10^{b} | 0.19 | 0.135 | 0.095 | 0.350 |
| Copper, μg/mL | 1.71^{ab} | 1.61^{ab} | 1.80^{a} | 1.59^{b} | 1.65^{ab} | 0.07 | 0.270 | 0.342 | 0.700 |
| Selenium, ng/mL | 139.0 | 134.9 | 143.2 | 135.6 | 142.0 | 4.16 | 0.534 | 0.491 | 0.235 |
| Cobalt, ng/mL | 0.369 | 0.319 | 0.334 | 0.322 | 0.343 | 0.020 | 0.425 | 0.089 | 0.415 |
| Molybdenum, ng/mL | 19.83^{a} | 20.02^{a} | 20.57^{a} | 20.55^{a} | 16.33^{b} | 1.12 | 0.056 | 0.905 | 0.025 |

^{ab}Means within a row without a common superscript are different (P < 0.05).
NC = Negative control
PC = Positive control
AMIN = supplemented with Availa-Copper, Availa-Zinc, and Availa-Manganese.
EC1 = Enzyme chelated feed additive composition 1
EC2 = Enzyme chelated feed additive composition 2

### Conclusion

Feed additives with enzyme chelated trace minerals improved growth performance of nursery pigs and also improved bioavailability of select trace-minerals.

### Example 7

Evaluation of enzyme chelated feed additive on nursery pigs compared to conventional products for growth performance.

### Experimental Design and Animal Management

A total of 320 crossbred barrows and were used in two replicate experiments with 160 pigs in each experiment. Pigs were weaned at 21 days of age with a mean body weight of 6.48±0.11 kg for experiment 1 and 6.07±0.14 kg for experiment 2, averaging 6.27±0.09 kg for the overall study. Pigs were blocked by sex and body weight and subsequently randomly allotted within blocks to 1 of 4 dietary treatments. Pigs were housed in a total of 80 nursery pens with 4 pigs per pen, resulting in 20 blocks per dietary treatment. Each pen housed 2 barrows and 2 gilts. Pigs were allowed ad libitum access to feed and water during the 42-day experimental period. Fresh feed was added to the self-feeders as needed to ensure that fresh feed was always available. Feed consumption was calculated weekly from feed added to the feeder minus feed left in the feeder at the end of the feeding phase minus any waste feed removed from the feeders.

### Experimental Diets and Manufacturing

Dietary Treatments (Table 7) consisted of: (1) Diet with supplemental Diamond V-XPC (DVX) at an inclusion rate of 4 lbs/ton of feed; (2) Diet with supplemental Zinpro Availa-3 AvailaSow (AVS) at an inclusion rate of 1.5 lbs/ton; (3) Enzyme chelated feed additive composition 1 (EC1) at an inclusion rate of 4 lbs/ton; and (4) Enzyme chelated feed additive composition 2 (EC2) at an inclusion rate of 1.5 lbs/ton.

EC1 contains a minimum of 1.0×10⁹ Saccharomyces cerevisiae cells per kg of product and contains 2.6% zinc, 1.5% manganese, and 0.9% copper from chelated sources. EC2 contains a minimum of 1.0×10⁹ Saccharomyces cerevisiae cells per kg of product and contains 5.2% zinc, 3.0% manganese, and 1.8% copper from chelated sources. These compositions were compared with DVX and AVS. DVX is a yeast culture product containing Saccharomyces cerevisiae yeast and the media on which it was grown. In the present study DVX was fed at 4 lbs/ton throughout the nursery and directly compared to EC1 also included at 4 lbs/ton of complete feed. EC1 provided a calculated level of 2×10⁶ yeast cells/kg of complete feed. AVS contains 6.67% zinc, 2.67% manganese, and 1.34% copper from amino acid complexes. EC2 was compared directly with AVS at the same dietary inclusion level and provided comparable supplemental complexed trace-mineral concentrations, but also provided yeast cells, at a calculated level of 7.5×10⁵ yeast cells/kg of complete feed.

Treatments were specifically designed such that specific comparisons could be made between the diet containing DVX and the diet with EC1 and a second comparison between the diet containing AVS and the diet containing EC2. Diets were fed in 3 phases throughout the nursery (Table 8), with each phase being fed for 2 weeks. To create the experimental diets, a basal mix was manufactured first, containing all ingredients, except experimental treatments. This mix was then divided into 4 equal size batches and the appropriate type and level of test products were added to create the final dietary treatments (Table 8), In addition, diets were color coded for visual confirmation of treatments. Diets were placed in 22.7 kg paper bags, labeled, and stored for subsequent use. All diets were prepared and provided to pigs in meal form.

TABLE 7
Description of dietary treatments with inclusion rates (lbs/ton)
of test products added to a common basal diet (Table 8)¹

| | Diet | | | | | | | |
|---|---|---|---|---|---|---|---|---|
| | DVX | AVS | EC1 | EC2 | Added trace-minerals | | | |
| | Color | | | | from additive | | | |
| | Red | Orange | Blue | Green | Zn | Mn | Cu | Fe |
| Basal | 1993 | 1993 | 1993 | 1993 | | | | |
| Corn | 2 | 4.5 | 2 | 4.5 | | | | |
| Microgrits | 1 | 1 | 1 | 1 | | | | |
| DVX | 4 | 0 | 0 | 0 | 0 | 0 | 0 | 0 |
| AVS | 0 | 1.5 | 0 | 0 | 50 | 20 | 10 | 0 |
| EC1 | 0 | 0 | 4 | 0 | 52 | 30 | 18 | 30 |
| EC2 | 0 | 0 | 0 | 1.5 | 39 | 22.5 | 13.5 | 11.25 |
| SUM | 2000 | 2000 | 2000 | 2000 | | | | |

¹The composition of the basal diets for nursery pig diet Phase 1, 2, and 3 is shown in Table 2. Microgrits were included to color code diets for treatment verification. DV - XPC is Diamond V - XPC. Information on the test products is shown in Appendix 1.

### Sampling and Measurements

Pigs were weighed individually at the start of the study and on day 14, 28, and 42, which coincided with diet phase changes. Average daily gain (ADG) was calculated from body weight measurements considering the number of pigs in the pen and the number of days in the period. Feed additions to the feeders were recorded and feed remaining in the feeders was determined at the end of each period at the same time pigs were weighed. Feed disappearance was calculated from feed added to the feeder minus feed left in the feeder. Average daily feed intake (ADFI) per pen was then calculated from feed consumed during the period divided by the total number of days for pigs within each pen. Feed efficiency was calculated as the ratio of average daily gain for each period (or phase) divided by the average daily feed intake for the period.

TABLE 8
Composition of the experimental basal diets (as-fed basis)

| | Nursery diet | | |
|---|---|---|---|
| Ingredient | Phase 1 | Phase 2 | Phase 3 |
| Corn, 7.5% CP | 50.00 | 57.73 | 62.61 |
| Plasma, spray-dried | 5.00 | 2.00 | 0.00 |
| Soybean meal, 47% CP | 20.00 | 25.00 | 32.00 |
| Enzymatically treated soy protein¹ | 7.75 | 5.00 | 0.00 |
| Whey permeate | 12.50 | 5.00 | 0.00 |
| Poultry fat | 1.50 | 1.50 | 1.50 |
| L-lysine · HCl | 0.315 | 0.400 | 0.417 |
| DL-methionine | 0.190 | 0.199 | 0.188 |
| L-threonine | 0.100 | 0.146 | 0.159 |
| L-tryptophan | 0.027 | 0.039 | 0.042 |
| L-valine | 0.000 | 0.035 | 0.019 |
| Monocalcium phosphate, 21% P | 1.307 | 1.386 | 1.396 |
| Limestone | 0.910 | 0.969 | 0.972 |
| Salt | 0.201 | 0.401 | 0.501 |
| Vitamin premix | 0.050 | 0.050 | 0.050 |
| Trace mineral premix | 0.150 | 0.150 | 0.150 |
| Calculated composition | | | |
| ME, Mcal/kg | 3.43 | 3.41 | 3.39 |
| NE, Mcal/kg | 2.48 | 2.48 | 2.48 |
| Crude protein, % | 22.38 | 21.30 | 20.41 |
| ADF, % | 2.77 | 3.15 | 3.48 |
| NDF, % | 6.95 | 8.01 | 8.87 |
| Crude fat, % | 4.37 | 4.68 | 4.90 |
| Total lysine, % | 1.58 | 1.50 | 1.43 |
| Calcium, % | 0.80 | 0.78 | 0.75 |
| Total phosphorus, % | 0.77 | 0.73 | 0.69 |
| Available phosphorus, % | 0.50 | 0.43 | 0.37 |
| Digestible phosphorus, % | 0.47 | 0.41 | 0.36 |
| Lactose, % | 10.00 | 4.00 | 0.00 |
| Standardized ileal digestible amino acids | | | |
| Lys % | 1.45 | 1.38 | 1.30 |
| Thr % | 0.90 | 0.86 | 0.81 |
| Met % | 0.47 | 0.48 | 0.47 |
| Met + Cys % | 0.84 | 0.80 | 0.75 |
| Trp % | 0.29 | 0.28 | 0.26 |
| Ile % | 0.81 | 0.77 | 0.74 |
| Val % | 0.97 | 0.92 | 0.84 |

¹Experimental products were added as appropriate in replacement of corn (See Table 1 for details)
²Hamlet HP300

### Analyzed Proximate Composition

The analyzed composition of the experimental diets was reasonably consistent with the expected composition (Table 9). This is not surprising given the fact that all diets were manufactured from a common basal and that the basal consisted of 99.65% of the overall final diet. Therefore, no large variation in diet composition was expected, except for differences in trace-mineral concentrations per the design of the study. For trace-mineral analysis, the concentrations of copper, manganese, and zinc were generally higher for the diets supplemented with AVS, EC1 and EC2 compared to the diet supplemented with DVX, the latter not providing additional trace-minerals via the product. According to the product labels and as shown in Table 7, supplemental products provided 50, 52, and 39 ppm of zinc, 20, 30, and 22.5 ppm of manganese, and 10, 18, and 13.5 ppm of copper for AVS, EC1, and EC2, respectively. According to the analyzed composition averaging the results across all three phases, diets supplemented with AVS, EC1, and EC2 had 64.8, 53.2, and 33.0 ppm more zinc, 29.0, 38.4, and 27.1 ppm more manganese, and 15.0, 14.6, and 6.5 ppm more copper, respectively, compared to the diet supplemented with DVX. Considering the variation in trace-mineral analysis, these results are in good agreement with targeted values.

TABLE 9
Analyzed proximate composition, calcium, phosphorus, copper, iron,
manganese, and zinc concentrations in the experimental diets¹

| | Nursery Phase 1 | | | | Nursery Phase 2 | | | | Nursery Phase 3 | | | |
|---|---|---|---|---|---|---|---|---|---|---|---|---|
| Treatment: | A | B | C | D | A | B | C | D | A | B | C | D |
| Moisture, % | 10.96 | 10.79 | 10.89 | 10.75 | 11.50 | 11.35 | 11.33 | 10.87 | 11.48 | 11.38 | 11.30 | 11.30 |
| Protein, % | 21.10 | 21.47 | 21.48 | 21.95 | 19.46 | 19.40 | 19.98 | 19.82 | 21.40 | 19.79 | 19.51 | 19.39 |
| Fat, % | 4.00 | 3.98 | 3.76 | 4.01 | 3.61 | 3.69 | 3.82 | 4.08 | 3.22 | 3.13 | 3.16 | 3.60 |
| Fiber, % | 2.24 | 2.37 | 1.98 | 2.07 | 2.02 | 1.88 | 1.97 | 1.89 | 2.04 | 2.09 | 2.05 | 2.00 |
| Ash, % | 5.66 | 5.87 | 5.75 | 5.84 | 5.82 | 5.76 | 5.63 | 5.76 | 6.69 | 6.83 | 6.82 | 6.23 |
| Ca, % | 0.81 | 0.91 | 0.86 | 0.86 | 0.98 | 0.98 | 0.88 | 0.91 | 1.17 | 1.40 | 1.27 | 1.08 |
| P, % | 0.65 | 0.67 | 0.65 | 0.65 | 0.61 | 0.65 | 0.63 | 0.60 | 0.55 | 0.64 | 0.58 | 0.55 |
| Cu, ppm | 32.7 | 52.7 | 44.5 | 45.3 | 25.5 | 29.6 | 29.1 | 24.1 | 24.6 | 45.5 | 53.1 | 32.9 |
| Fe, ppm | 265 | 242 | 311 | 254 | 282 | 314 | 292 | 285 | 280 | 346 | 329 | 277 |
| Mn, ppm | 79 | 114 | 119 | 120 | 66 | 82 | 101 | 88 | 64 | 100 | 104 | 82 |
| Zn, ppm | 157 | 245 | 220 | 229 | 171 | 206 | 216 | 189 | 158 | 229 | 209 | 167 |

¹Duplicate samples of experimental diets (coded as two separate samples) were submitted and analyzed. Treatments were coded as follows: A = DVX, B = AVS, C = EC1, and D = EC2.

### Results

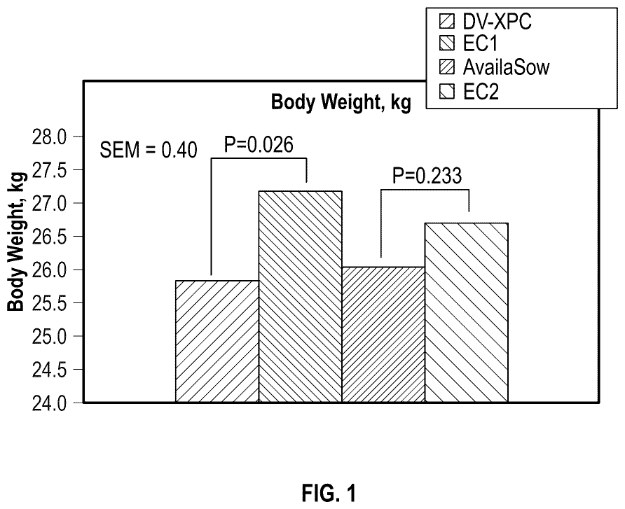

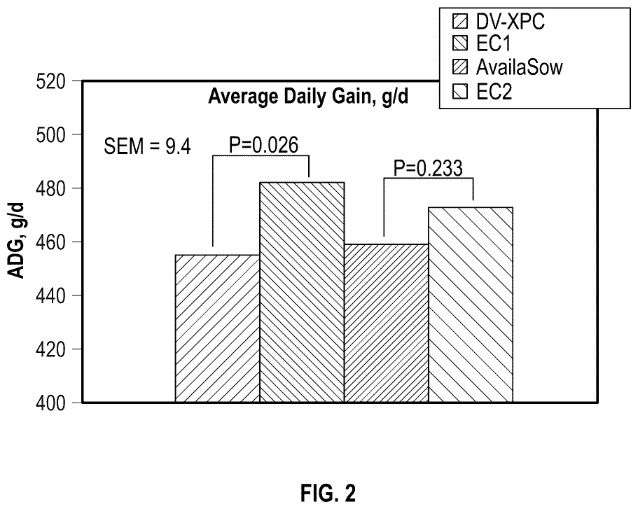

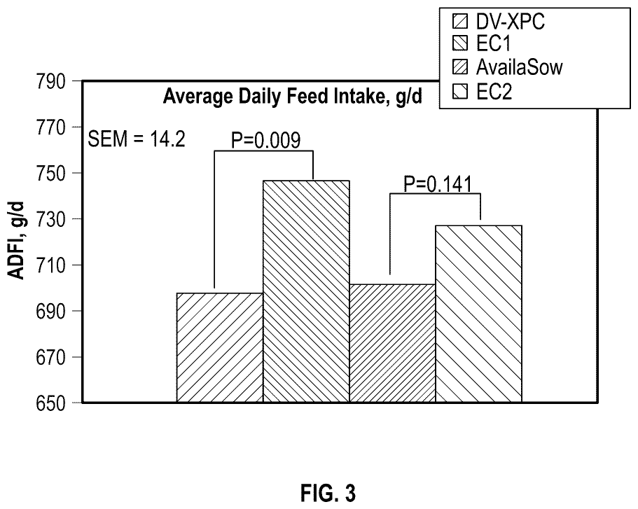

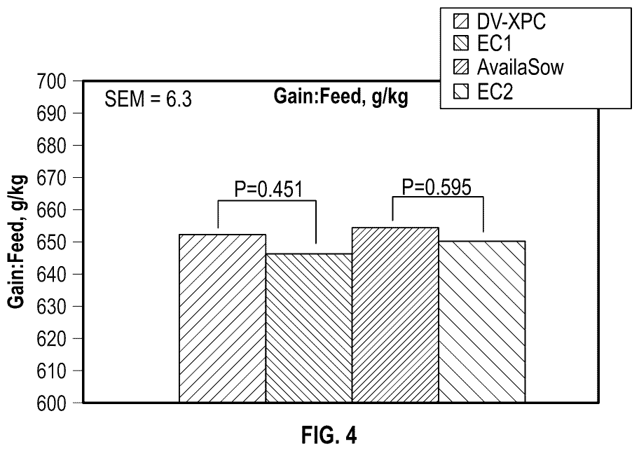

Data from both groups (experiment 1 and 2) were combined to assess the impact of dietary treatments on outcome variables, which is shown in Table 10. Evaluating the combined pig performance data, significant differences for main treatment effects were observed for pig body weight after 14 days on test, ADG from day 0 to 14, ADFI for day 0 to 14 and overall (P≤0.044). When evaluating preplanned comparisons (DVX vs. EC1 and AVS vs. EC2), whether main treatment effects were significant or not, body weight was greater for pigs fed EC1 compared to DVX on day 14 (P=0.016), day 28 (P=0.035), and day 42 (P=0.026), indicating an advantage of 1.35 kg in body weight for pigs fed EC1. Pigs fed EC2 tended (P=0.081) to have a greater body weight after 14 days on test compared to pigs fed AVS, but this difference did not maintain significance throughout the study. The increase in body weights observed resulted in improved ADG for pigs fed EC1 compared to DVX from day 0 to 14 (P=0.016) and overall (P=0.026) and tended to result in improved ADG in pigs fed EC2 compared to AVS for day 0 to 14 (P=0.081). Average daily feed intake was greater for pigs fed EC1 compared to DVX for day 0 to 14 (P=0.002) and overall (P=0.009) and tended to be greater for day 14 to 28 (P=0.080) and day 28 to 42 (P=0.063). Pigs fed EC2 had greater feed intake for day 0 to 14 (P=0.042) and tended to have greater feed intake for day 28 to 42 (P=0.100) compared to pigs fed AVS. No differences were observed in gain: feed, suggesting that the improvements in growth observed in the current study were the result of increased feed intake. Generally, growth performance was greater for pigs fed diets containing the EC1 and EC2, with greater effects being observed for the EC1 containing diets. FIG. 1-4 illustrates better performance of EC1 and EC2 over conventional products.

TABLE 10
Growth performance of nursery pigs fed diets with yeast- and
trace-mineral-based supplements. Experiment 1 and 2 combined¹

| | | | | | P values | | |
|---|---|---|---|---|---|---|---|
| Dietary treatments | | | | | | 1 vs. | 2 vs. |
| DVX | AVS | EC1 | EC2 | SEM | Trt² | 3 | 4 |

Body weight, kg

| | | | | | | | | |
|---|---|---|---|---|---|---|---|---|
| Day 0 | 6.27 | 6.27 | 6.27 | 6.27 | _{—}³ | _{—}³ | | |
| Day 14 | 8.79^{a} | 8.86^{ab} | 9.36^{c} | 9.26^{bc} | 0.16 | 0.044 | 0.016 | 0.081 |
| Day 28 | 16.14^{a} | 16.20^{a} | 17.06^{b} | 16.44^{ab} | 0.28 | 0.133 | 0.035 | 0.554 |
| Day 42 | 25.83^{a} | 26.03^{ab} | 27.18^{b} | 26.70^{ab} | 0.40 | 0.108 | 0.026 | 0.233 |

Average daily gain, g/d

| | | | | | | | | |
|---|---|---|---|---|---|---|---|---|
| Day 0 to 14 | 179.5^{a} | 185.1^{ab} | 220.9^{c} | 213.1^{bc} | 11.2 | 0.044 | 0.016 | 0.081 |
| Day 14 to 28 | 525.4 | 523.9 | 549.5 | 512.9 | 14.0 | 0.310 | 0.256 | 0.580 |
| Day 28 to 42 | 691.4 | 701.8 | 723.6 | 730.0 | 16.8 | 0.382 | 0.206 | 0.237 |
| Overall | 465.7^{a} | 470.4^{ab} | 497.8^{b} | 486.4^{ab} | 9.4 | 0.108 | 0.026 | 0.233 |

Average daily feed intake, g/d

| | | | | | | | | |
|---|---|---|---|---|---|---|---|---|
| Day 0 to 14 | 249.6^{a} | 253.1^{a} | 305.8^{b} | 286.8^{b} | 11.5 | 0.005 | 0.002 | 0.042 |
| Day 14 to 28 | 715.9 | 721.2 | 761.7 | 727.7 | 172.0 | 0.282 | 0.080 | 0.787 |
| Day 28 to 42 | 1152.9 | 1157.8 | 1220.0 | 1213.4 | 23.6 | 0.128 | 0.063 | 0.100 |
| Overall | 705.6^{a} | 710.3^{a} | 763.1^{b} | 740.1^{ab} | 14.2 | 0.032 | 0.009 | 0.141 |

Gain:feed, g/kg

| | | | | | | | | |
|---|---|---|---|---|---|---|---|---|
| Day 0 to 14 | 714.7 | 715.4 | 727.3 | 739.8 | 22.5 | 0.853 | 0.709 | 0.445 |
| Day 14 to 28 | 734.0^{a} | 727.3^{ab} | 718.8^{ab} | 705.5^{b} | 9.9 | 0.232 | 0.306 | 0.122 |
| Day 28 to 42 | 600.6 | 607.3 | 594.9 | 605.4 | 9.2 | 0.777 | 0.681 | 0.881 |
| Overall | 661.0 | 663.1 | 653.8 | 658.4 | 6.3 | 0.779 | 0.451 | 0.595 |

¹Data represent a total of 80 pens and 20 observations per dietary treatment.
²Main treatment effect P value.
³Initial body weight was used as a covariate in the analysis of the data (Values were: 6.26, 6.26, 6.29, and 6.28 with SEM of 0.006 and main treatment P = 0.008).
^{abc}Means within a row without a common superscript are different (P < 0.05). Differences are shown regardless of whether the main treatment effect P value was significantly different.

### INDUSTRIAL APPLICABILITY

The claimed invention is applicable to the animal health and animal agriculture industries.

What is claimed is:

1.-24. (canceled)

25. A method of manufacturing chelated minerals, comprising:
adding a composition into a volume of water, the composition comprising a chelating agent and one or more metal salts to form a solution, the one or more metal salts comprise one or more trace minerals, wherein the chelating agent comprises one or more enzymes;
chelating the one or more trace minerals with the one or more enzymes by mixing the solution;
filtering the solution to separate undissolved substances from a filtrate; and
drying the filtrate to form a powder.

26. The method of claim 25, further comprising adding a silica medium in the volume of water.

27. The method of claim 26, the silica medium further comprising diatomaceous earth.

28. The method of claim 27, wherein the diatomaceous earth is a buffer colloid to stabilize the solution subsequent to the pH being adjusted.

29. The method of claim 25, wherein the one or more enzymes comprises one or more digestive enzymes.

30. The method of claim 29, wherein the one or more digestive enzymes comprises protease, cellulase, amylase, xylanase, hemicellulase, beta glucanase, phytase, lipase, mannanase, or a combination thereof.

31. The method of claim of 30, wherein the one or more digestive enzymes comprises a multiple enzyme mixture, the multiple enzyme mixture comprising: amylase in an amount between and inclusive of 25.0% to 30.0% of the multiple enzyme mixture, hemicellulase in an amount between and inclusive of 5.0% to 8.0% of the multiple enzyme mixture, cellulase in an amount between and inclusive of 10.0% to 15.0% of the multiple enzyme mixture, xylanase in amount between and inclusive of 5.0% to 7.0% of the multiple enzyme mixture, beta glucanase in an amount between 1.0% to 3.0% of the multiple enzyme mixture, protease in an amount between and inclusive of 20.0% to 40.0% of the multiple enzyme mixture, phytase in an amount between and inclusive of 2.0% to 5.0% of the multiple enzyme mixture, mannanase in an amount between and inclusive of 0.5% to 1.0% of the multiple enzyme mixture, and lipase in an amount between and inclusive of 2.0% to 5.0% of the multiple enzyme mixture.

32. The method of claim 25, wherein the one or more enzymes comprises 20% to 95% w/w of the composition.

33. The method of claim 25, wherein the chelating agent is devoid of free amino acids.

34. (canceled)

35. The method of claim 25, wherein chelating the one or more trace minerals with the one or more enzymes by mixing the solution occurs at room temperature.

36. The method of claim 25, further comprising adjusting the pH of the solution to between and inclusive of 6.5-6.7 prior to chelating the one or more trace minerals with the one or more enzymes by mixing the solution.

37. The method of claim 36, wherein the pH of the solution is adjusted with an organic acid.

38. The method of claim 37, wherein the organic acid comprises citric acid.

39. The method of claim 25, the composition further comprising Beta glucan.

40. The method of claim 39, wherein the Beta glucan comprises β-(1-3), (1-6)-D-glucan.

41. The method of claim 39, wherein the Beta glucan is derived from fungi.

42. The method of claim 39, the composition further comprising one or more probiotics.

43. The method of claim 42, wherein the one or more probiotics comprises Bacillus subtilus, Saccharomyces cerevisiae, Aspergillus niger, Aspergillus oryzae, Lactobacillus acidophilus, Lactobacillus bulgaricus, Enterococcus faecium, or a combination thereof.

44. (canceled)

45. (canceled)

46. (canceled)

47. (canceled)

48. The method of claim 25, wherein the one or more trace minerals comprises zinc copper, manganese, cobalt, iron, or a combination thereof.

49. The method of claim 25, wherein the method performs a single mixing step after all of the one or more metal salts are added to the solution.
